(19) United States
(12) Patent Application Publication
(10) Pub. No.: US 2015/0155802 A1
(43) Pub. Date: Jun. 4, 2015

(54) Control Device for Rotating Electrical Machine, and Rotating Electrical Machine Drive System Including Control Device

(71) Applicant: Kazuhide Miyata, Toyota-shi (JP)

(72) Inventor: Kazuhide Miyata, Toyota-shi (JP)

(73) Assignee: TOYOTA JIDOSHA KABUSHIKI KAISHA, Toyota-shi, Aichi-ken (JP)

(21) Appl. No.: 14/406,660

(22) PCT Filed: Sep. 4, 2013
(86) PCT No.: PCT/IB2013/002027

§ 371 Date: Dec. 9, 2014

(30) Foreign Application Priority Data
Sep. 11, 2012 (JP) 2012-199235

(51) Int. Cl. H02P 6/00

(52) U.S. Cl. CPC H02P 6/001; H02P 6/002

(57) ABSTRACT

A control device (16) for a rotating electrical machine (12) having a stator coil and a rotor magnet (24), and a rotating electrical machine drive system including the control device are provided. The control device includes: a counter-electromotive voltage calculation unit (62) that calculates a counter-electromotive voltage that is generated in the stator coil during operation of the rotating electrical machine (12); a refrigerant temperature acquisition unit (64) that acquires a temperature of refrigerant that cools the rotating electrical machine (12); a characteristic correction unit (66) that corrects a counter-electromotive voltage characteristic, which defines a correlation between a temperature of the rotor magnet (24) and the counter-electromotive voltage, on the basis of the calculated counter-electromotive voltage and the acquired temperature of refrigerant; and a temperature estimating unit (68) that estimates the temperature of the rotor magnet (24) using the corrected counter-electromotive voltage characteristic.

### BACKGROUND OF THE INVENTION

1. Field of the Invention

The invention relates to a control device for a rotating electrical machine and a rotating electrical machine drive system including the control device and, more particularly, to an improved control device for a rotating, electrical machine of which a rotor is cooled by refrigerant and a rotating electrical machine drive system including the control device.

2. Description of Related Art

In a rotating electrical machine having a rotor magnet formed of a permanent magnet, demagnetization of the rotor magnet due to a temperature change becomes a problem, so it is required to detect the temperature of the rotor magnet. Therefore, it is conceivable that the temperature of the rotor magnet is directly measured with the use of a temperature sensor; however, the rotor is configured to be rotatable, so it is impossible to directly install the temperature sensor on the rotor.

As a method of estimating the temperature of the rotor magnet, for example, Japanese Patent Application Publication No. 2008-206340 (JP 2008-206340 A) describes that the temperature of a rotor magnet is estimated on the basis of the temperature of refrigerant of a rotating electrical machine. In addition, Japanese Patent Application Publication No. 2005-012914 (JP 2005-012914 A) describes that the temperature of a rotor magnet is estimated on the basis of a counter-electromotive voltage that is generated in each stator coil as a rotating electrical machine.

When the temperature of the rotor magnet is estimated on the basis of the temperature of refrigerant, it is necessary to consider that the correlation between a temperature of refrigerant and a temperature of the rotor magnet varies on the basis of a state of a load on the rotating electrical machine. In addition, when the temperature of the rotor magnet is estimated on the basis of the counter-electromotive voltage that is generated in each stator coil, it is required to acquire a counter-electromotive voltage characteristic that defines the correlation between a counter-electromotive voltage and a temperature of the rotor magnet in advance. When there is a deviation between the counter-electromotive voltage characteristic acquired in advance in this way and the actual counter-electromotive voltage characteristic of the rotor magnet, there is a problem that the accuracy of estimating the temperature of the rotor magnet decreases.

### SUMMARY OF THE INVENTION

The invention provides a control device for a rotating electrical machine, which improves the accuracy of estimating a rotor magnet by appropriately correcting a counter-electromotive voltage characteristic, and a rotating electrical machine drive system including the control device.

An aspect of the invention provides a control device for a rotating electrical machine having a stator coil and a rotor magnet. The control device includes a counter-electromotive voltage calculation unit, a refrigerant temperature acquisition unit, a characteristic correction unit and a temperature estimating unit. The counter-electromotive voltage calculation unit is configured to calculate a counter-electromotive voltage that is generated in the stator coil during operation of the rotating electrical machine. The refrigerant temperature acquisition unit is configured to acquire a temperature of refrigerant that cools the rotating electrical machine. The characteristic correction unit is configured to correct a. counter-electromotive voltage characteristic on the basis of the calculated counter-electromotive voltage and the acquired temperature of refrigerant, the counter-electromotive voltage characteristic defining a correlation between a temperature of the rotor magnet and the counter-electromotive voltage. The temperature estimating unit is configured to estimate the temperature of the rotor magnet using the corrected counter-electromotive voltage characteristic.

In the control device according to the invention, the characteristic correction unit may be configured to obtain the corrected counter-electromotive voltage characteristic by setting a rate of change in the counter-electromotive voltage characteristic to substantially the same rate of change that is a predetermined ratio of a change in the counter-electromotive voltage to a change in the temperature of the rotor magnet.

In the control device according to the invention, the rotor magnet may have a refrigerant flow path through which the refrigerant flows inside the rotor magnet, and the refrigerant flow path may be provided adjacently along a longitudinal direction of the rotor magnet.

In the control device according to the invention, the refrigerant temperature acquisition unit may be configured to acquire the temperature of the refrigerant in a cooling period in which the rotating electrical machine operates in a predetermined constant operation condition.

Another aspect of the invention provides a rotating electrical machine drive system may comprise the control device that is configured to estimate the temperature of the rotor magnet on the basis of the counter-electromotive voltage characteristic corrected using the above-described control device and to limit a driving current of the rotating electrical machine when the estimated temperature is higher than or equal to a predetermined value.

With the above configuration, the characteristic correction unit corrects the counter-electromotive voltage characteristic on the basis of the calculated counter-electromotive voltage and the acquired temperature of refrigerant. With the thus configured control device, it is possible to correct the counter-electromotive voltage characteristic to an appropriate one on the basis of the temperature of refrigerant substantially equivalent to the temperature of the rotor magnet, so it is possible to improve the accuracy of estimating the temperature of the rotor magnet. By setting the rate of change in the counter-electromotive voltage characteristic to the same rate of change, it is possible to correct the counter-electromotive voltage characteristic to an appropriate one that matches an actual state.

With the above configuration, refrigerant flows through the refrigerant flow path that is provided adjacently along the longitudinal direction of the rotor magnet. Thus, it is possible to increase the correlativity between the temperature of the rotor magnet and the temperature of refrigerant at the time of correcting the counter-electromotive voltage characteristic.

With the above configuration, the temperature of refrigerant is detected during the cooling period in which the rotating electrical machine operates in the predetermined constant operation condition. Thus, it is possible to increase the correlativity between the temperature of the rotor magnet and the temperature of refrigerant at the time of correcting the counter-electromotive voltage characteristic.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a view that shows a rotating electrical machine drive system including a control device for a rotating electrical machine according to an embodiment of the invention;

FIG. 2 is a flowchart that shows the steps of estimating a temperature of the rotor magnet of the rotating electrical machine using a counter-electromotive voltage characteristic according to the embodiment of the invention; and

FIG. 3 is a counter-electromotive voltage characteristic graph that shows, the correlation between a counter-electromotive voltage that is generated in each stator coil and a temperature of the rotor magnet according to the embodiment of the invention.

### DETAILED DESCRIPTION OF EMBODIMENTS

An embodiment of a control device for a rotating electrical machine according to the invention and a rotating electrical machine drive system including the control device will be described in detail with reference to the accompanying drawings. Hereinafter, like reference numerals denote similar elements in all the drawings, and the overlap description is omitted.

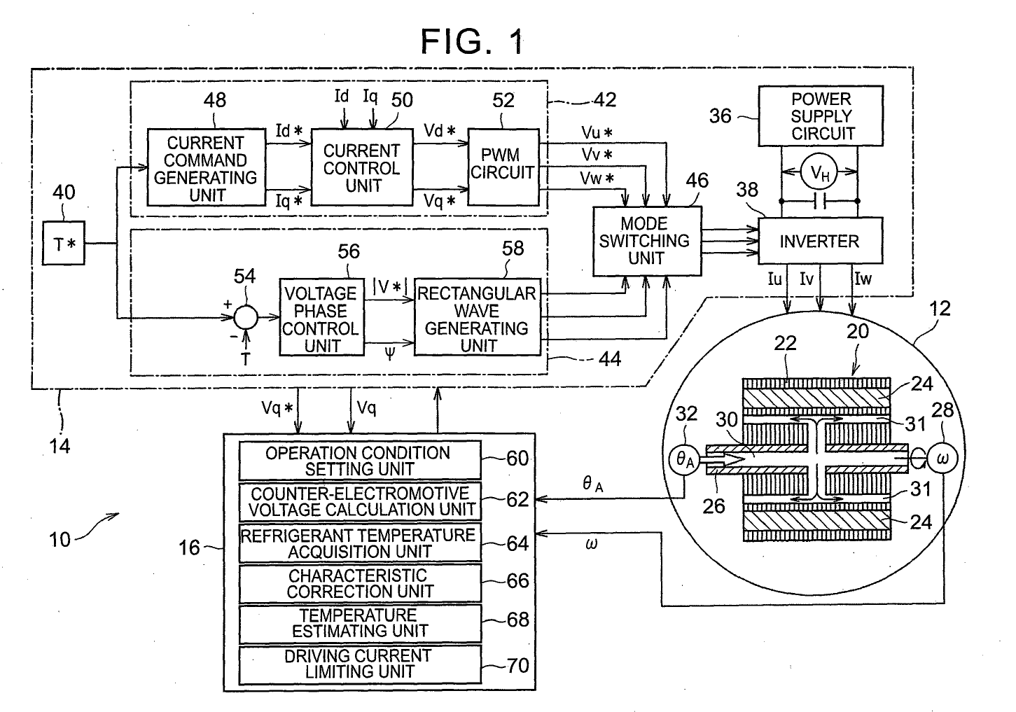

FIG. 1 is a view that shows the configuration of a rotating electrical machine drive system 10 for a vehicle. The rotating electrical machine drive system 10 includes a rotating electrical machine 12, a drive circuit 14 and a control device 16. The rotating electrical machine 12 is mounted on the vehicle. The drive circuit 14 is connected to the rotating electrical machine 12. The control device 16 controls the drive circuit 14.

The rotating electrical machine 12 is a motor generator that is mounted on the vehicle. That is, the rotating electrical machine 12 functions as an electric motor during power running of the vehicle and functions as a generator during braking of the vehicle. The rotating electrical machine 12 includes an annular stator and a rotor 20. The stator has stator coils that generate revolving magnetic fields. The rotor 20 is arranged on the radially inner side of the stator. FIG. 1 shows a cross-sectional view by extracting part of the rotor 20 of the rotating electrical machine 12.

The rotor 20 is formed such that a rotor magnet 24 is embedded in a rotor core 22 formed by laminating electromagnetic steel plates. A rotary shaft 26 is connected at the central axis of the rotor core 22. The rotor magnet 24 is made of a permanent magnet, such as a neodymium magnet that is a rare-earth sintered magnet. The neodymium magnet has such a temperature characteristic that the magnetic force reduces as the temperature rises. The temperature characteristic is a reversible demagnetization characteristic while the temperature is not so high; however, when the temperature further rises, irreversible demagnetization occurs depending on the strength of demagnetizing field received. As the demagnetization of the rotor magnet 24 progresses, the output torque of the rotating electrical machine 12 decreases. Therefore, a demagnetization threshold temperature θₜₕ is set as a temperature for not causing irreversible demagnetization, and it is required to execute control for bringing the temperature of the rotor magnet 24 to at or below the demagnetization threshold temperature θₜₕ. An example of this control method will be described later.

The rotary shaft 26 is rotatably supported by a bearing provided on a motor case (not shown). When predetermined drive currents are supplied to the stator coils of the stator, the stator generates revolving magnetic fields. Thus, the rotor 20 rotates by cooperation action between the revolving magnetic fields and the rotor magnet 24, and torque is output to the rotary shaft 26. A rotation angular velocity detecting unit 28 detects the rotation angular velocity ω of the rotary shaft 26, and a detected result is transmitted to the control device 16 via an adequate signal line.

A refrigerant flow path 30 provided so as to extend through the rotary shaft 26 is a flow path through which refrigerant for cooling the rotor 20 is passed. The refrigerant flow path 31 is a flow path that branches off from the refrigerant flow path 30 and that is provided adjacently along the longitudinal direction of the rotor magnet 24 in the rotor core 22. A fluid called automatic transmission fluid (ATF) is used as the refrigerant that flows through the refrigerant flow paths 30, 31. A refrigerant temperature sensor 32 detects the temperature θ_{A} of ATF that is the refrigerant, and a detected result is transmitted to the control device 16 via an adequate signal line.

The drive circuit 14 includes a power supply circuit 36, an inverter 38, a torque command unit 40, a sinusoidal wave control circuit 42, a rectangular wave control circuit 44 and a mode switching circuit 46. The inverter 38 is connected to the power supply circuit 36. The torque command unit 40 issues a torque command value T*.

The power supply circuit 36 is a high-voltage direct-current power supply that supplies a system voltage V_{H} to the inverter 38. The power supply circuit 36 includes , a power supply, such as a lithium ion battery pack, a nickel metal hydride battery pack and a large-capacitance capacitor, and an adequate step-up/step-down circuit. About 500 to 600 V is used as the system voltage V_{H}.

The inverter 38 is a circuit that is connected to the stator of the rotating electrical machine 12. The inverter 38 includes a plurality of switching elements and a plurality of antiparallel diodes, and has the function of converting electric power between direct-current power and alternating-current power. The inverter 38 has a direct-current/alternating-current conversion function of, when the rotating electrical machine 12 is caused to function as an electric motor, converting direct-current power from the power supply circuit 36 side to three-phase driving powers and then supplying the three-phase driving powers to the rotating electrical machine 12 as alternating-current driving powers. In addition, the inverter 38 has an alternating-current/direct-current conversion function of, when the rotating electrical machine 12 is caused to function as a generator, converting three-phase regenerated powers from the rotating electrical machine 12 to direct-current power and then supplying the direct-current power to the power supply circuit 36 side as charging power.

The torque command unit 40 calculates the torque command value T* on the basis of, for example, an accelerator operation of a driver that is a user of the vehicle, and applies the torque command value T* to the sinusoidal wave control circuit 42 and the rectangular wave control circuit 44. The sinusoidal wave control circuit 42 is a circuit that generates a pulse width modulation (PWM) drive signal and then supplies the PWM drive signal to the inverter 38 when a control mode of the rotating electrical machine 12 is a sinusoidal wave control mode. The sinusoidal wave control circuit 42 is a circuit that executes current feedback control for feeding back an actual current value to a current command value. The sinusoidal wave control circuit 42 includes a current command generating unit 48, a current control unit 50 and a PWM circuit 52.

The current command generating unit 48 receives the torque command value T*, and outputs a d-axis current command value I_{d}^{*} and a q-axis current command value I_{q}* in vector control. The current control unit 50 obtains a d-axis actual current value I_{d} and a q-axis actual current value I_{q} by converting I_{U}, I_{V}, I_{W} that are actual values of three-phase driving currents of the rotating electrical machine 12, and outputs a d-axis voltage command value V_{d}* and a q-axis voltage command value V_{q}* by executing proportional-plus-integral (PI) control such that a d-axis current deviation ΔI_{d}=(I_{d}*−I_{d}) and a q-axis current deviation ΔI_{q}=(I_{q}*−I_{q}), obtained from the above values, become zero. The PWM circuit 52 outputs three-phase driving voltage command values V_{U}*, V_{V}*, V_{W}* by carrying out pulse conversion on V_{d}*, V_{q}*.

The rectangular wave control circuit 44 is a circuit that generates a rectangular wave drive signal and then supplies the rectangular wave drive signal to the inverter 38 when the control mode of the rotating electrical machine 12 is a rectangular wave control mode. The rectangular wave control circuit 44 is a circuit that executes torque feedback control for feeding back an actual torque value T to the torque command value T*. The rectangular wave control circuit 44 includes a subtracter 54, a voltage phase control'unit 56 and a rectangular wave generating unit 58.

The subtracter 54 obtains the actual torque value T of the rotating electrical machine 12 from the d-axis actual current value I_{d} and q-axis actual current value I_{q} of the rotating electrical machine 12, and then outputs a torque deviation ΔT=(T*−T). The voltage phase control unit 56 outputs the absolute value |V*| of a command voltage vector and a command voltage phase Ψ such that the torque deviation becomes zero. Here, the absolute value of the command voltage vector is a value that is calculated by |V*|=(V_{d}*²+V_{q}*²)^{1/2}. The rectangular wave generating unit 58 outputs the rectangular wave drive signal having |V*| and Ψ.

The mode switching circuit 46 is a change circuit that selects the control mode of the rotating electrical machine 12 in accordance with a predetermined switching criterion and then sets one of the PWM circuit 52 and the rectangular wave generating unit 58 as a connected circuit of the inverter 38 in accordance with the determined control mode. A modulation factor=|V*|/V_{H} may be used as the predetermined switching criterion. For example, the sinusoidal wave control mode may be selected when the modulation factor is smaller than or equal to 0.61, and the rectangular wave control mode may be selected when the modulation factor is 0.78.

When the modulation factor is 0.61 to 0.78, an overmodulation control mode may be selected as the control mode of the rotating electrical machine 12. When the overmodulation control mode is used, an overmodulation control circuit that supplies an overmodulation drive signal is provided in the drive circuit 14. The overmodulation control circuit has a configuration similar to that of the sinusoidal wave control circuit 42 except that the modulation factor that is applied in the PWM circuit 52 is 0.61 to 0.78, so the detailed description is omitted.

The control device 16 has the function of estimating the temperature θ_{M} of the rotor magnet 24 of the rotating electrical machine 12 using a counter-electromotive voltage characteristic that defines the correlation between a counter-electromotive voltage and a temperature. For this reason, the control device 16 includes an operation condition setting unit 60, a counter-electromotive voltage calculation unit 62, a refrigerant temperature acquisition unit 64, a characteristic correction unit 66, a temperature estimating unit 68 and a driving current limiting unit 70. The operation condition setting unit 60 sets an operation condition of the rotating electrical machine 12. The counter-electromotive voltage calculation unit 62 calculates a counter-electromotive voltage that is generated in each stator coil during operation of the rotating electrical machine 12. The refrigerant temperature acquisition unit 64 acquires the temperature of ATF that cools the rotating electrical machine 12. The characteristic correction unit 66 corrects the counter-electromotive voltage characteristic on the basis of the calculated counter-electromotive voltage and the acquired temperature of refrigerant. The temperature estimating unit 68 estimates the temperature θ_{M} of the rotor magnet 24 using the corrected counter-electromotive voltage characteristic. The driving current limiting unit 70 limits the driving currents of the rotating electrical machine 12. The above functions may be implemented by executing software, and, specifically, may be implemented by executing a rotating electrical machine drive control program. Part of these functions may be implemented by hardware.

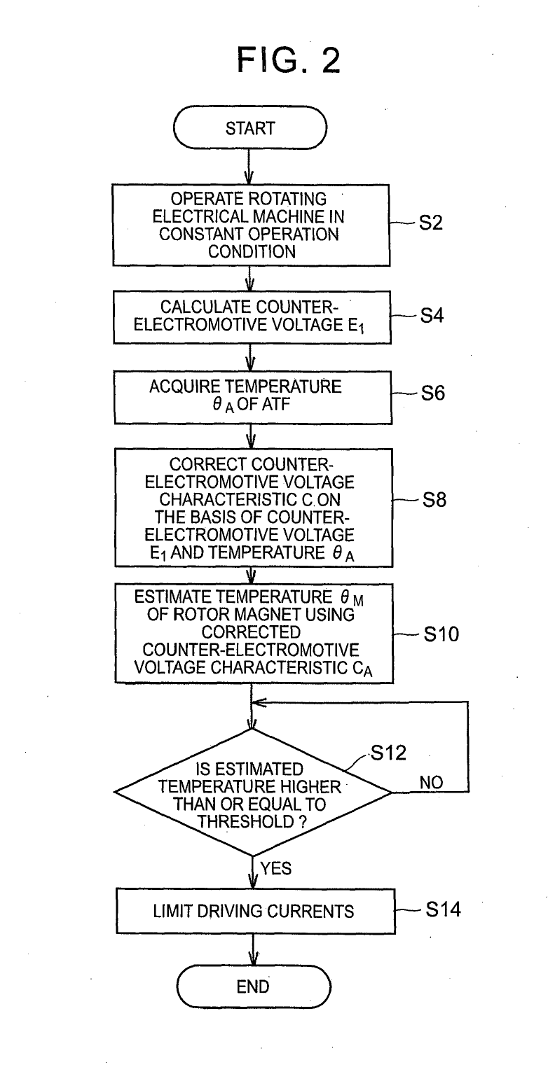

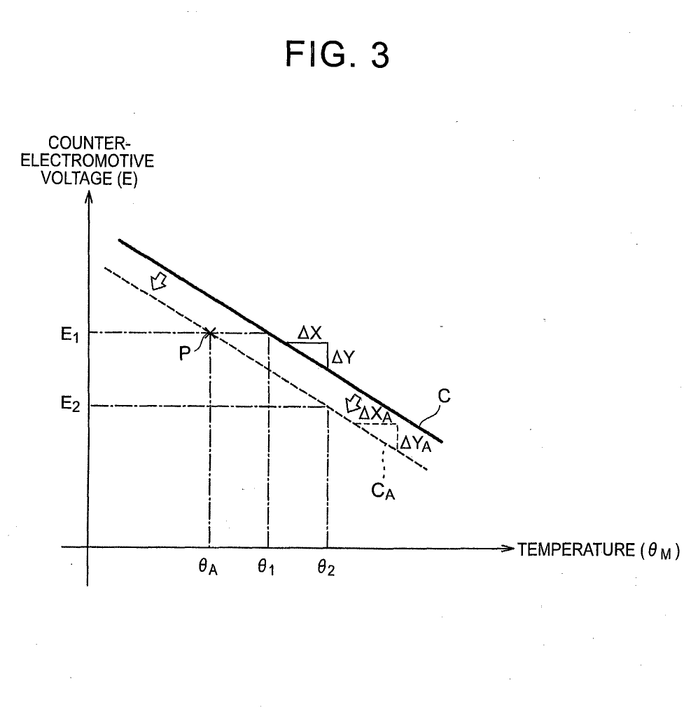

The operation of the above-described configuration will be described in detail with reference to FIG. 1 to FIG. 3. FIG. 2 is a flowchart that shows the steps of estimating the temperature θ_{M} of the rotor magnet 24 of the rotating electrical machine 12 using the counter-electromotive voltage characteristic. The steps respectively correspond to processes of the rotating electrical machine drive control program. FIG. 3 is a graph that shows the counter-electromotive voltage characteristic C indicating the correlation between a counter-electromotive voltage E that is generated in each stator coil and a temperature θ_{M} of the rotor magnet 24. In the counter-electromotive voltage characteristic C, the X axis represents the temperature θ_{M} of the rotor magnet 24, and the Y axis represents the counter-electromotive voltage E. The counter-electromotive voltage characteristic C may be obtained through an experiment, simulation, or the like, in advance. The counter-electromotive voltage characteristic C is stored in an adequate memory of the control device 16, and is loaded where necessary.

Initially, the rotating electrical machine 12 is operated in a predetermined constant operation condition (S2). The constant operation condition is desirably set such that the correlativity between the temperature θ_{M} of the rotor magnet 24 and the temperature θ_{A} of the ATF. For example, it is suitable that the rotation speed of the rotating electrical machine 12 is set to 1000 rpm and the output torque of the rotating electrical machine 12 is set to 10 Nm. This process is executed by the function of the operation condition setting unit 60 of the control device 16.

Subsequently, the q-axis voltage command value V_{q}*, the q-axis actual voltage value V_{q} and the rotation angular velocity co of the rotating electrical machine 12 are acquired during an ATF circulation cooling period in which the rotating electrical machine 12 operates in the above-described operation condition, and a counter-electromotive voltage E₁ that is generated in each stator coil of the rotating electrical machine 12 is calculated (S4). This process is executed by the function of the counter-electromotive voltage calculation unit 62 of the control device 16. As shown in FIG. 3, if the counter-electromotive voltage E₁ and the counter-electromotive voltage characteristic C are used, the temperature θ_{M} of the rotor magnet 24 is estimated as θ₁. However, there may be a deviation between an actual counter-electromotive voltage characteristic of the rotor magnet 24 and the counter-electromotive voltage characteristic C acquired in advance, so the counter-electromotive voltage characteristic C needs to be corrected to a counter-electromotive voltage characteristic C_{A} close to the actual characteristic of the rotor magnet 24. Here, as shown in FIG. 3, the rate of change (ΔY/ΔX) in the counter-electromotive voltage characteristic C is equal to the rate of change (ΔY_{A}/ΔX_{A}) in the counter-electromotive voltage characteristic C_{A}. That is, the slope of the counter-electromotive voltage characteristic C_{A} is equal to the slope of the counter-electromotive voltage characteristic C.

During the ATF circulation cooling period, the temperature θ_{A} of ATF flowing through the refrigerant flow paths 30, 31 is acquired from the refrigerant temperature sensor 32 (S6). This process is executed by the function of the refrigerant temperature acquisition unit 64 of the control device 16.

Subsequently, the counter-electromotive voltage characteristic C is corrected to the counter-electromotive voltage characteristic C_{A} indicating the actual characteristic of the rotor magnet 24 on the basis of the counter-electromotive voltage Eₗ calculated in S4 and the temperature θ_{A} acquired in S6 (S8). Specifically, in the XY coordinate system on which the counter-electromotive voltage characteristic C is shown, an intersection P of a straight line Y=E₁ with a straight line X=θ_{A}, and, as shown in FIG. 3, the counter-electromotive voltage characteristic C is corrected to the counter-electromotive voltage characteristic C_{A} that passes through the intersection P. This process is executed by the function of the characteristic correction unit 66 of the control device 16.

After that, the temperature θ_{M} of the rotor magnet 24 is obtained using the corrected counter-electromotive voltage characteristic C_{A} (S10). Specifically, in the case where a counter-electromotive voltage detected by the counter-electromotive voltage calculation unit 62 after correction is, for example, E₂, if the counter-electromotive voltage characteristic C_{A} is used, the temperature θ_{M} of the rotor magnet 24 is estimated as θ₂ as shown in FIG. 3. This process is executed by the function of the temperature estimating unit 68 of the control device 16.

It is determined whether the temperature estimated on the basis of the counter-electromotive voltage characteristic C_{A} is higher than or equal to the threshold θₜₕ (S12). When the estimated temperature is not higher than or equal to the threshold θₜₕ in S12, the process returns to S12 again after a lapse of a predetermined period of time. This process is executed by the function of the temperature estimating unit 68 of the control device 16.

When the estimated temperature is higher than or equal to the threshold θₜₕ in S12, the three-phase driving currents I_{U}, I_{V}, I_{W} of the rotating electrical machine 12 are limited (S14). At this time, the three-phase driving currents I_{U}, I_{V}, I_{W} of the rotating electrical machine 12 are limited to at or below a predetermined value in order to set the temperature θ_{M} of the rotor magnet 24 to at or below the threshold θₜₕ. This process is executed by the function of the driving current limiting unit 70 of the control device 16.

As described above, the control device 16 of the rotating electrical machine drive system 10 corrects the counter-electromotive voltage characteristic C on the basis of the counter-electromotive voltage E₁ and the temperature θ_{A} of ATF. Thus, it is possible to correct the counter-electromotive voltage characteristic C to the counter-electromotive voltage characteristic C_{A} close to the actual characteristic of the rotor magnet 24 on the basis of the temperature θ_{A} of ATF substantially equivalent to the temperature θ_{M} of the rotor magnet 24, so it is possible to improve the accuracy of estimating the temperature θ_{M} of the rotor magnet 24.

In the rotating electrical machine drive system 10, ATF flows through the refrigerant flow path 31 provided adjacently along the longitudinal direction of the rotor magnet 24. Thus, it is possible to increase the correlativity between a temperature θ_{M} of the rotor magnet and a temperature θ_{A} of ATF at the time of correcting the counter-electromotive voltage characteristic C as described above.

In the .rotating electrical machine drive system 10, the temperature θ_{A} of ATF is detected during a cooling period in which the rotating electrical machine 12 operates in a constant operation condition on which the correlativity between a temperature θ_{M} of the rotor magnet and a temperature θ_{A} of ATF is increased. Thus, it is possible to increase the correlativity between a temperature θ_{M} of the rotor magnet 24 and a temperature θ_{A} of ATF at the time of correcting the counter-electromotive voltage characteristic C as described above.

The invention is not limited to the above-described embodiment. The invention may be improved or modified in various forms within the matter described in the appended claims of the present application and equivalents thereof.

In the above-described rotating electrical machine drive system 10, the motor generator that is mounted on the vehicle is described as the rotating electrical machine 12; instead, the rotating electrical machine 12 may be a rotating electrical machine other than the rotating electrical machine mounted on the vehicle. The neodymium magnet is described as the permanent magnet; instead, the permanent magnet may be a rare-earth magnet other than the neodymium magnet, such as a samarium-cobalt magnet and a samarium-iron-nitrogen magnet. Other than the rare-earth magnet, a ferrite magnet and an alnico magnet are applicable. ATF is described as the refrigerant for cooling the rotor 20; instead, the refrigerant may be oily refrigerant other than the ATF and may be aqueous refrigerant or gaseous refrigerant where appropriate.

In the above-described rotating electrical machine drive system 10, the control mode of the rotating electrical machine 12 is switched between the rectangular wave control mode and the sinusoidal wave control mode; instead, the control mode may be switched among three control modes that further include the overmodulation control mode.

1. A control device for a rotating electrical machine having a stator coil and a rotor magnet, comprising:
a counter-electromotive voltage calculation unit configured to calculate a counter-electromotive voltage that is generated in the stator coil during operation of the rotating electrical machine;
a refrigerant temperature acquisition unit configured to acquire a temperature of refrigerant that cools the rotating electrical machine;
a characteristic correction unit configured to correct a counter-electromotive voltage characteristic on the basis of the calculated counter-electromotive voltage and the acquired temperature of refrigerant, the counter-electromotive voltage characteristic, defining a correlation between a temperature of the rotor magnet and the counter-electromotive voltage; and
a temperature estimating unit configured to estimate the temperature of the rotor magnet using the corrected counter-electromotive voltage characteristic.

2. The control device according to claim 1, wherein
the characteristic correction unit is configured to obtain the corrected counter-electromotive voltage characteristic by setting a rate of change in the counter-electromotive voltage characteristic to substantially the same rate of change that is a predetermined ratio of a change in the counter-electromotive voltage to a change in the temperature of the rotor magnet.

3. The control device according to claim 1, wherein
the rotor magnet has a refrigerant flow path through which the refrigerant flows inside the rotor magnet, and the refrigerant flow path is provided adjacently along a longitudinal direction of the rotor magnet.

4. The control device according to claim 1, wherein
the refrigerant temperature acquisition unit is configured to acquire the temperature of the refrigerant in a cooling period in which the rotating electrical machine operates in a predetermined constant operation condition.

5. A rotating electrical machine drive system comprising:
a counter-electromotive voltage calculation unit configured to calculate a counter-electromotive voltage that is generated in the stator coil during operation of the rotating electrical machine;
a refrigerant temperature acquisition unit configured to acquire a temperature of refrigerant that cools the rotating electrical machine;
a characteristic correction unit configured to correct a counter-electromotive voltage characteristic on the basis of the calculated counter-electromotive voltage and the acquired temperature of refrigerant, the counter-electromotive voltage characteristic defining a correlation between a temperature of the rotor magnet and the counter-electromotive voltage;
a temperature estimating unit configured to estimate the temperature of the rotor magnet using the correct counter-electromotive voltage characteristic; and
a driving current limiting unit configured to limit a driving current of the rotating electrical machine when the estimated temperature of the rotor magnet is higher than or equal to a predetermined value.

6. The rotating electrical machine drive system according to claim 5, wherein
the characteristic correction unit is configured to obtain the corrected counter-electromotive voltage characteristic by setting a rate of change in the counter-electromotive voltage characteristic to substantially the same rate of change that is a predetermined ratio of a change in the counter-electromotive voltage to a change in the temperature of the rotor magnet.

7. The rotating electrical machine drive system according to claim 5, wherein
the rotor magnet has a refrigerant flow path through which the refrigerant flows inside the rotor magnet, and the refrigerant flow path is provided adjacently along a longitudinal direction of the rotor magnet.

8. The rotating electrical machine drive system according to claim 5, wherein
the refrigerant temperature acquisition unit is configured to acquire the temperature of the refrigerant in a cooling period in which the rotating electrical machine operates in a predetermined constant operation condition.
